(19) United States
(12) Patent Application Publication
(10) Pub. No.: US 2018/0299899 A1
(43) Pub. Date: Oct. 18, 2018

(54) LOCALIZED COLLECTION OF AMBIENT DATA

(71) Applicant: Neato Robotics, Inc., Newark, CA (US)

(72) Inventors: Sarath Suvarna, Fremont, CA (US); Bryant Pong, San Jose, CA (US)

(21) Appl. No.: 15/487,216

(22) Filed: Apr. 13, 2017

(51) Int. Cl. G05D 1/02; H04W 24/08; H04M 1/725; B25J 5/00; B25J 19/00

(52) U.S. Cl. CPC G05D 1/0231; H04W 24/08; H04M 1/72572; G05D 2201/0215; B25J 19/005; Y10S 901/01; B25J 5/007

(57) ABSTRACT

Embodiments provide methods and apparatus for effectively using signal strength and other data from a robot to optimize robot operation. In one embodiment, the cleaning robot can interact with other home controllers over a network to optimize the operation of the cleaning robot. In one embodiment, the cleaning robot measures a variety of data as it travels through a space, and generates a map (e.g., a heat map). The data is provided in different layers for easy display and selection by a user. In one embodiment, the cleaning robot can act as a hub for communicating with other home controllers and coordinating actions.

### BACKGROUND OF THE INVENTION

The present invention relates to robots which collect data, and in particular to cleaning robots with different data collection capabilities.

There have been proposals to use household robots, such as cleaning robots, to collect various additional data. For example, a number of published applications suggest the collection of WiFi signal strength data (See US Pub. 20150312774; US Pub. 20150197010; US Pub. 20130196684). US Pub. 20150312774 describes a robot for collecting wireless signal measurements indoors and generating a color-coded heat map and recommending access point device locations.

Robots have been proposed to also collect air quality, humidity and temperature data (See US Pub. No. 20140207281 and US Pub. No. 20140207282). That data can be communicated to a stationary air purifier, humidifier or thermostat for activation as needed, or for operating shades or other connected devices (see US Pub. No. 20160282863, which also discloses other robot sensors, in particular an IR radiation detector, a camera, an ambient temperature sensor, an ambient light sensor, an acoustic sensor (e.g., microphone), a motion detector (e.g., a passive IR photodiode), an ultrasonic sensor, a pressure sensor, an air quality sensor, and a moisture sensor). The information can be used to turn lights off, operate an automatic lock, etc. The robot can also respond to sensors by returning to its dock when occupancy is detected, and turning off to reduce noise when a phone call is detected. (see US Pub. No. 20160282863).

US Pub. No. 20040244138 describes a robot cleaner that includes a germicidal ultraviolet lamp and an electrostatic filter to remove some of the particulate exhausted by the vacuum cleaner. US Pub. No. 20080056933 describes a Sterilization Robot that provides a germicidal energy source—an ultraviolet (UV) lamp, a radiofrequency electric field (RFEF) apparatus, an electrostatic field apparatus, or a heat generating device capable of producing heat at a temperature of at least about 80° C. An allergen sensor is referenced that would be desirable to have to detect ragweed; dust; dust mites; pollen; pet dander; and mold spores. However, there is no description of how these would be detected, or what type of sensor could do this detection. The disclosures of the above publications are hereby incorporated herein by reference as providing background details on device elements and operations.

### BRIEF SUMMARY OF THE INVENTION

Embodiments provide methods and apparatus for effectively using signal quality and other data from a robot to optimize robot operation. The signal quality data can include one or more of intensity (strength), reliability, estimated bandwidth, historical bandwidth, etc.

In one embodiment, the collected data is used to modify the operation of the robot or other home electronic control systems. For example, signal quality data for a WiFi or other wireless network or communication channel is analyzed to determine an optimum location for a charging base station for the robot. The signal quality data can also be used to indicate to a user where control may be lost, or to automatically avoid such areas, or to switch over to a local control mode. Where there is a dual band router, the robot can determine which band to use depending upon signal quality and interference at different locations. This information can be communicated to a smart router, or to a user device or processor that controls the router.

In one embodiment, the cleaning robot can interact with other home controllers over a network to optimize the operation of the cleaning robot. For example, when the robot is using a camera for object detection or other purposes, the amount of light can be detected to determine if there is sufficient light for capturing good images. If there is insufficient light, the robot can communicate through a wireless network to a light controller to have particular lights turned on. In another example, the cleaning robot can includes a humidity sensor for detecting potential mold areas, and can treat them with a UV lamp on the robot. The robot can also have a fan turned on, since air flow can help eliminate the moisture. Alternately, a room de-humidifier may be available to be turned on.

In one embodiment, the cleaning robot measures a variety of data as it travels through a space, and generates a map (e.g., a heat map). The data is provided in different layers for easy display and selection by a user.

In one embodiment, the cleaning robot acts as a hub for communicating with other home controllers and coordinating actions. A user interface for controlling the cleaning robot also provides interfaces for operating other home controllers, such as a thermostat, lighting system, automatic door and/or window locking system, etc.

### BRIEF DESCRIPTION OF THE DRAWINGS

FIG. 1 is a diagram of a cleaning robot with a LIDAR turret according to an embodiment.

FIG. 2 is a diagram of a cleaning robot and charging station according to an embodiment.

FIG. 3 is a diagram of the underside of a cleaning robot according to an embodiment.

FIG. 4 is a diagram of a smartphone control application display for a cleaning robot according to an embodiment.

FIG. 5 is a diagram of a smart watch control application display for a cleaning robot according to an embodiment.

FIG. 6 is a diagram of a the electronic system for a cleaning robot according to an embodiment.

FIG. 7 is a simplified block diagram of a representative computing system and client computing system usable to implement certain embodiments of the present invention.

FIG. 8 is a diagram of an embodiment of a cleaning map indicating an optimum location for a cleaning device.

FIG. 9 is a diagram of an embodiment of a display with different map layers for different measured conditions.

### DETAILED DESCRIPTION OF THE INVENTION

### Overall Architecture

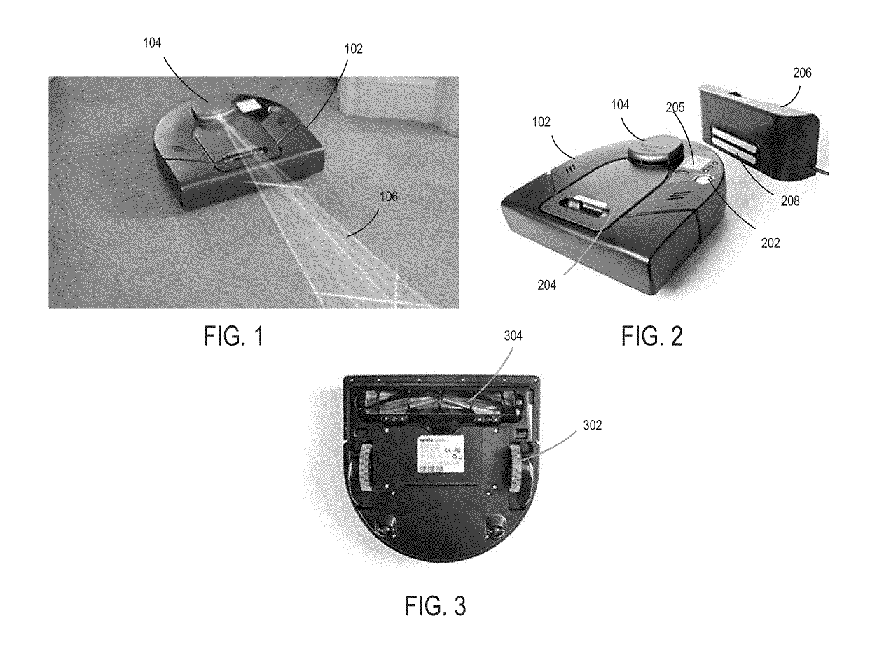

FIG. 1 is a diagram of a cleaning robot with a LIDAR turret according to an embodiment. A cleaning robot 102 has a LIDAR (Light Detection and Ranging) turret 104 which emits a rotating laser beam 106. Detected reflections of the laser beam off objects are used to calculate both the distance to objects and the location of the cleaning robot. One embodiment of the distance calculation is set forth in U.S. Pat. No. 8,996,172, “Distance sensor system and method,” the disclosure of which is incorporated herein by reference. The collected data is also used to create a map, using a SLAM (Simultaneous Location and Mapping) algorithm. One embodiment of a SLAM algorithm is described in U.S. Pat. No. 8,903,589, “Method and apparatus for simultaneous localization and mapping of mobile robot environment,” the disclosure of which is incorporated herein by reference.

FIG. 2 is a diagram of a cleaning robot and charging station according to an embodiment. Cleaning robot 102 with turret 10 is shown. Also shown is a cover 204 which can be opened to access a dirt collection bag and the top side of a brush. Buttons 202 allow basic operations of the robot cleaner, such as starting a cleaning operation. A display 205 provides information to the user. Cleaning robot 102 can dock with a charging station 206, and receive electricity through charging contacts 208.

FIG. 3 is a diagram of the underside of a cleaning robot according to an embodiment. Wheels 302 move the cleaning robot, and a brush 304 helps free dirt to be vacuumed into the dirt bag.

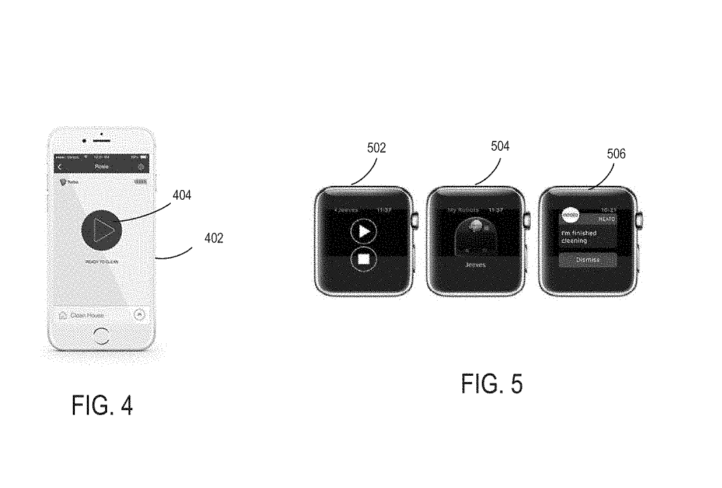

FIG. 4 is a diagram of a smartphone control application display for a cleaning robot according to an embodiment. A smartphone 402 has an application that is downloaded to control the cleaning robot. An easy to use interface has a start button 404 to initiate cleaning.

FIG. 5 is a diagram of a smart watch control application display for a cleaning robot according to an embodiment. Example displays are shown. A display 502 provides and easy to use start button. A display 504 provides the ability to control multiple cleaning robots. A display 506 provides feedback to the user, such as a message that the cleaning robot has finished.

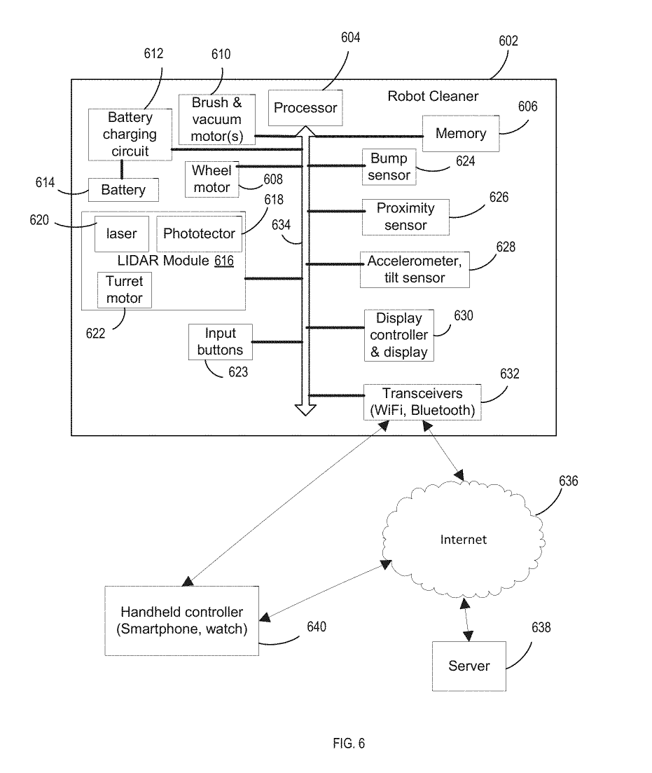

FIG. 6 is a high level diagram of a the electronic system for a cleaning robot according to an embodiment. A cleaning robot 602 includes a processor 604 that operates a program downloaded to memory 606. The processor communicates with other components using a bus 634 or other electrical connections. In a cleaning mode, wheel motors 608 control the wheels independently to move and steer the robot. Brush and vacuum motors 610 clean the floor, and can be operated in different modes, such as a higher power intensive cleaning mode or a normal power mode.

LIDAR module 616 includes a laser 620 and a detector 616. A turret motor 622 moves the laser and detector to detect objects up to 360 degrees around the cleaning robot. There are multiple rotations per second, such as about 5 rotations per second. Various sensors provide inputs to processor 604, such as a bump sensor 624 indicating contact with an object, proximity sensor 626 indicating closeness to an object, and accelerometer and tilt sensors 628, which indicate a drop-off (e.g., stairs) or a tilting of the cleaning robot (e.g., upon climbing over an obstacle). Examples of the usage of such sensors for navigation and other controls of the cleaning robot are set forth in U.S. Pat. No. 8,855,914, “Method and apparatus for traversing corners of a floored area with a robotic surface treatment apparatus,” the disclosure of which is incorporated herein by reference. Other sensors may be included in other embodiments, such as a dirt sensor for detecting the amount of dirt being vacuumed, a motor current sensor for detecting when the motor is overloaded, such as due to being entangled in something, a floor sensor for detecting the type of floor, and an image sensor (camera) for providing images of the environment and objects.

A battery 614 provides power to the rest of the electronics though power connections (not shown). A battery charging circuit 612 provides charging current to battery 614 when the cleaning robot is docked with charging station 206 of FIG. 2. Input buttons 623 allow control of robot cleaner 602 directly, in conjunction with a display 630. Alternately, cleaning robot 602 may be controlled remotely, and send data to remote locations, through transceivers 632.

Through the Internet 636, and/or other network(s), the cleaning robot can be controlled, and can send information back to a remote user. A remote server 638 can provide commands, and can process data uploaded from the cleaning robot. A handheld smartphone or watch 640 can be operated by a user to send commands either directly to cleaning robot 602 (through Bluetooth, direct RF, a WiFi LAN, etc.) or can send commands through a connection to the internet 636. The commands could be sent to server 638 for further processing, then forwarded in modified form to cleaning robot 602 over the internet 636.

### Computer Systems for Media Platform and Client System

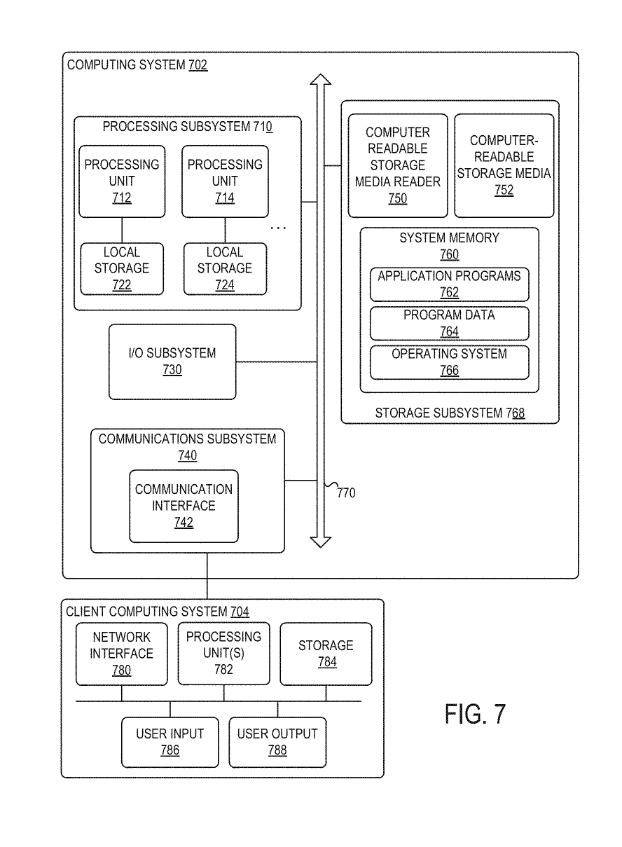

Various operations described herein may be implemented on computer systems. FIG. 7 shows a simplified block diagram of a representative computing system 702 and client computing system 704 usable to implement certain embodiments of the present invention. In various embodiments, computing system 702 or similar systems may implement the cleaning robot processor system, remote server, or any other computing system described herein or portions thereof. Client computing system 704 or similar systems may implement user devices such as a smartphone or watch with a robot cleaner application.

Computing system 702 may be one of various types, including processor and memory, a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 702 may include processing subsystem 710. Processing subsystem 710 may communicate with a number of peripheral systems via bus subsystem 770. These peripheral systems may include I/O subsystem 730, storage subsystem 768, and communications subsystem 740.

Bus subsystem 770 provides a mechanism for letting the various components and subsystems of server computing system 704 communicate with each other as intended. Although bus subsystem 770 is shown schematically as a single bus, alternative embodiments of the bus subsystem may utilize multiple buses. Bus subsystem 770 may form a local area network that supports communication in processing subsystem 710 and other components of server computing system 702. Bus subsystem 770 may be implemented using various technologies including server racks, hubs, routers, etc. Bus subsystem 770 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 730 may include devices and mechanisms for inputting information to computing system 702 and/or for outputting information from or via computing system 702. In general, use of the term “input device” is intended to include all possible types of devices and mechanisms for inputting information to computing system 702. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 702 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 710 controls the operation of computing system 702 and may comprise one or more processing units 712, 714, etc. A processing unit may include one or more processors, including single core processor or multicore processors, one or more cores of processors, or combinations thereof. In some embodiments, processing subsystem 710 may include one or more special purpose co-processors such as graphics processors, digital signal processors (DSPs), or the like. In some embodiments, some or all of the processing units of processing subsystem 710 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 722, 724. Any type of processors in any combination may be included in processing unit(s) 712, 714.

In some embodiments, processing subsystem 710 may be implemented in a modular design that incorporates any number of modules (e.g., blades in a blade server implementation). Each module may include processing unit(s) and local storage. For example, processing subsystem 710 may include processing unit 712 and corresponding local storage 722, and processing unit 714 and corresponding local storage 724.

Local storage 722, 724 may include volatile storage media (e.g., conventional DRAM, SRAM, SDRAM, or the like) and/or non-volatile storage media (e.g., magnetic or optical disk, flash memory, or the like). Storage media incorporated in local storage 722, 724 may be fixed, removable or upgradeable as desired. Local storage 722, 724 may be physically or logically divided into various subunits such as a system memory, a ROM, and a permanent storage device. The system memory may be a read-and-write memory device or a volatile read-and-write memory, such as dynamic random access memory. The system memory may store some or all of the instructions and data that processing unit(s) 712, 714 need at runtime. The ROM may store static data and instructions that are needed by processing unit(s) 712, 714. The permanent storage device may be a non-volatile read-and-write memory device that may store instructions and data even when a module including one or more processing units 712, 714 and local storage 722, 724 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 722, 724 may store one or more software programs to be executed by processing unit(s) 712, 714, such as an operating system and/or programs implementing various server functions such as functions of UPP system 102, or any other server(s) associated with UPP system 102. “Software” refers generally to sequences of instructions that, when executed by processing unit(s) 712, 714 cause computing system 702 (or portions thereof) to perform various operations, thus defining one or more specific machine implementations that execute and perform the operations of the software programs. The instructions may be stored as firmware residing in read-only memory and/or program code stored in non-volatile storage media that may be read into volatile working memory for execution by processing unit(s) 712, 714. In some embodiments the instructions may be stored by storage subsystem 768 (e.g., computer readable storage media). In various embodiments, the processing units may execute a variety of programs or code instructions and may maintain multiple concurrently executing programs or processes. At any given time, some or all of the program code to be executed may be resident in local storage 722, 724 and/or in storage subsystem including potentially on one or more storage devices. Software may be implemented as a single program or a collection of separate programs or program modules that interact as desired. From local storage 722, 724 (or non-local storage described below), processing unit(s) 712, 714 may retrieve program instructions to execute and data to process in order to execute various operations described above.

Storage subsystem 768 provides a repository or data store for storing information that is used by computing system 702. Storage subsystem 768 provides a tangible non-transitory computer-readable storage medium for storing the basic programming and data constructs that provide the functionality of some embodiments. Software (programs, code modules, instructions) that when executed by processing subsystem 710 provide the functionality described above may be stored in storage subsystem 768. The software may be executed by one or more processing units of processing subsystem 710. Storage subsystem 768 may also provide a repository for storing data used in accordance with the present invention.

Storage subsystem 768 may include one or more non-transitory memory devices, including volatile and non-volatile memory devices. As shown in FIG. 7, storage subsystem 768 includes a system memory 760 and a computer-readable storage media 752. System memory 760 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 702, such as during start-up, may typically be stored in the ROM. The RAM typically contains data and/or program modules that are presently being operated and executed by processing subsystem 710. In some implementations, system memory 760 may include multiple different types of memory, such as static random access memory (SRAM) or dynamic random access memory (DRAM). Storage subsystem 768 may be based on magnetic, optical, semiconductor, or other data storage media. Direct attached storage, storage area networks, network-attached storage, and the like may be used. Any data stores or other collections of data described herein as being produced, consumed, or maintained by a service or server may be stored in storage subsystem 768.

By way of example, and not limitation, as depicted in FIG. 7, system memory 760 may store application programs 762, which may include client applications, Web browsers, mid-tier applications, relational database management systems (RDBMS), etc., program data 764, and one or more operating systems 766. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 752 may store programming and data constructs that provide the functionality of some embodiments. Software (programs, code modules, instructions) that when executed by processing subsystem 710 a processor provide the functionality described above may be stored in storage subsystem 768. By way of example, computer-readable storage media 752 may include non-volatile memory such as a hard disk drive, a magnetic disk drive, an optical disk drive such as a CD ROM, DVD, a Blu-Ray® disk, or other optical media. Computer-readable storage media 752 may include, but is not limited to, Zip® drives, flash memory cards, universal serial bus (USB) flash drives, secure digital (SD) cards, DVD disks, digital video tape, and the like. Computer-readable storage media 752 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 752 may provide storage of computer-readable instructions, data structures, program modules, and other data for computing system 702.

In certain embodiments, storage subsystem 768 may also include a computer-readable storage media reader 750 that may further be connected to computer-readable storage media 752. Together and, optionally, in combination with system memory 760, computer-readable storage media 752 may comprehensively represent remote, local, fixed, and/or removable storage devices plus storage media for storing computer-readable information.

In certain embodiments, computing system 702 may provide support for executing one or more virtual machines. Computing system 702 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 702. Accordingly, multiple operating systems may potentially be run concurrently by computing system 702. Each virtual machine generally runs independently of the other virtual machines.

Communication subsystem 740 provides an interface to other computer systems and networks. Communication subsystem 740 serves as an interface for receiving data from and transmitting data to other systems from computing system 702. For example, communication subsystem 740 may enable computing system 702 to establish a communication channel to one or more client computing devices via the Internet for receiving and sending information from and to the client computing devices.

Communication subsystem 740 may support both wired and/or wireless communication protocols. For example, in certain embodiments, communication subsystem 740 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 740 may provide wired network connectivity (e.g., Ethernet) in addition to or instead of a wireless interface.

Communication subsystem 740 may receive and transmit data in various forms. For example, in some embodiments, communication subsystem 740 may receive input communication in the form of structured and/or unstructured data feeds, event streams, event updates, and the like. For example, communication subsystem 740 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 740 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communication subsystem 740 may also be configured to output the structured and/or unstructured data feeds, event streams, event updates, and the like to one or more databases that may be in communication with one or more streaming data source computers coupled to computing system 702.

Communication subsystem 740 may provide a communication interface 742, e.g., a WAN interface, which may provide data communication capability between the local area network (bus subsystem 770) and a larger network, such as the Internet. Conventional or other communications technologies may be used, including wired (e.g., Ethernet, IEEE 802.3 standards) and/or wireless technologies (e.g., Wi-Fi, IEEE 802.11 standards).

Computing system 702 may operate in response to requests received via communication interface 742. Further, in some embodiments, communication interface 742 may connect computing systems 702 to each other, providing scalable systems capable of managing high volumes of activity. Conventional or other techniques for managing server systems and server farms (collections of server systems that cooperate) may be used, including dynamic resource allocation and reallocation.

Computing system 702 may interact with various user-owned or user-operated devices via a wide-area network such as the Internet. An example of a user-operated device is shown in FIG. 7 as client computing system 702. Client computing system 704 may be implemented, for example, as a consumer device such as a smart phone, other mobile phone, tablet computer, wearable computing device (e.g., smart watch, eyeglasses), desktop computer, laptop computer, and so on.

For example, client computing system 704 may communicate with computing system 702 via communication interface 742. Client computing system 704 may include conventional computer components such as processing unit(s) 782, storage device 784, network interface 780, user input device 786, and user output device 788. Client computing system 704 may be a computing device implemented in a variety of form factors, such as a desktop computer, laptop computer, tablet computer, smart phone, other mobile computing device, wearable computing device, or the like.

Processing unit(s) 782 and storage device 784 may be similar to processing unit(s) 712, 714 and local storage 722, 724 described above. Suitable devices may be selected based on the demands to be placed on client computing system 704; for example, client computing system 704 may be implemented as a “thin” client with limited processing capability or as a high-powered computing device. Client computing system 704 may be provisioned with program code executable by processing unit(s) 782 to enable various interactions with computing system 702 of a message management service such as accessing messages, performing actions on messages, and other interactions described above. Some client computing systems 704 may also interact with a messaging service independently of the message management service.

Network interface 780 may provide a connection to a wide area network (e.g., the Internet) to which communication interface 740 of computing system 702 is also connected. In various embodiments, network interface 780 may include a wired interface (e.g., Ethernet) and/or a wireless interface implementing various RF data communication standards such as Wi-Fi, Bluetooth, or cellular data network standards (e.g., 3G, 4G, LTE, etc.).

User input device 786 may include any device (or devices) via which a user may provide signals to client computing system 704; client computing system 704 may interpret the signals as indicative of particular user requests or information. In various embodiments, user input device 786 may include any or all of a keyboard, touch pad, touch screen, mouse or other pointing device, scroll wheel, click wheel, dial, button, switch, keypad, microphone, and so on.

User output device 788 may include any device via which client computing system 704 may provide information to a user. For example, user output device 788 may include a display to display images generated by or delivered to client computing system 704. The display may incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments may include a device such as a touchscreen that function as both input and output device. In some embodiments, other user output devices 788 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 712, 714 and 782 may provide various functionality for computing system 702 and client computing system 704, including any of the functionality described herein as being performed by a server or client, or other functionality associated with message management services.

It will be appreciated that computing system 702 and client computing system 704 are illustrative and that variations and modifications are possible. Computer systems used in connection with embodiments of the present invention may have other capabilities not specifically described here. Further, while computing system 702 and client computing system 704 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present invention may be realized in a variety of apparatus including electronic devices implemented using any combination of circuitry and software.

### Collection of Ambient Data

Robots can be used for a variety of operations, using different robots or the same robot. For example, an indoor cleaning robot may have a vacuum and brush, but may also have sensors to map WiFi signal quality, measure air quality, measure temperature, etc.

### Wireless Signal Quality

Embodiments provide methods and apparatus for effectively using signal quality and other data from a robot to optimize robot operation. In one embodiment, the collected data is used to modify the operation of the robot or other home electronic control systems. For example, signal quality data for a WiFi or other wireless network or communication channel is analyzed to determine an optimum location for a charging base station for the robot. The signal quality data can also be used to indicate to a user where control may be lost, or to automatically avoid such areas, or to switch over to another WiFi channel or access point, or switch over to a local control mode. Where there is a dual band router, the robot can determine which band to use depending upon signal quality and interference at different locations. This information can be communicated to a smart router, or to a user device or processor that controls the router.

In another aspect, the autonomous robotic device may contain one or more sensors to detect quality of wireless signals of various types, including cellular signals (for example, GMS or CDMA) and WiFi signals (whether some form of wireless signal according to the 802.11 standard, or another type of wireless signal). Detection of Bluetooth® and other signals of that type also may be included. Not only signal type, but also signal strength and signal frequency may be detected. For example, some connections operate at different frequencies, such as 2.4 GHz or 5 GHz. Other signal quality calculations may be done, such as, for example, signal intensity, signal reliability, estimated bandwidth, historical bandwidth, etc.

In still another aspect, one or more sensors in the autonomous robotic device may be able to detect the presence and operation of other electronic devices, such as smartphones, tablets, or other devices with an ability to communicate. In accordance with this feature, the robotic device may be able to communicate or otherwise make available the collected data to those devices.

In one embodiment, where low WiFi signal strength is detected, the robot automatically switches to a local mode where the mapping data is stored locally, and a simple mapping routine on the robot processor is used to track where the robot is and to lay virtual bread crumbs for returning to where there is good WiFi strength to upload the data for more robust mapping.

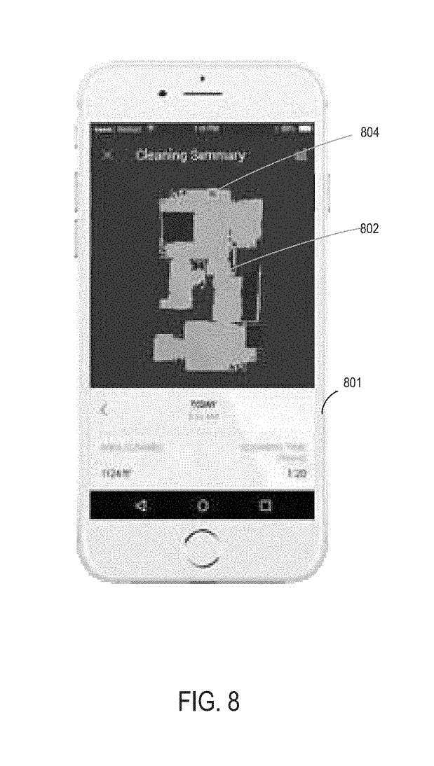

FIG. 8 is a diagram of an embodiment of a cleaning map indicating an optimum location for a cleaning device. A smartphone 801 (or tablet or other display device) shows a cleaning area 802 that has been mapped for WiFi (or other wireless signal) signal strength (e.g., mapping values between −10 dB and −80 dB). An indicator 804 shows an optimum location for a charging station for the cleaning robot, where there is a good WiFi signal. This allows the efficient upload and download of information while the cleaning robot is charging. In one embodiment, multiple possible locations are shown, since some locations may not be near an electrical outlet. The locations could be labelled in order of preference. In addition, where multiple locations are adequate, a location may be chosen that optimizes the cleaning time by optimizing the traversing path of the cleaning robot. In one example, this can be at one end or the other, along a longest dimension, of the area, so that the robot does not have to double back for cleaning other areas or measuring data in other areas.

In one embodiment, the cleaning robot includes a camera, and can upload pictures through a Wireless Local Area Network (WLAN) and the Internet to a server or other computer that performs object recognition. Electrical wall sockets can be recognized, and their location on the map noted. In one version, the presence of plugs already using the sockets can also be determined. The recommendation on the location of the charging station can then take into account not only the strength of the WiFi signal, but also the availability of a wall socket, either with or without existing plugs using it.

In one embodiment, the location of the WiFi wireless router, or multiple routers or repeaters (access point), is determined by determining the area with the strongest signal, which is assumed to be the router or repeater location. In order to optimize the charging station location with an available electrical socket, there may also be a recommendation to move the WiFi access point to optimize both charging location and coverage throughout the home or other area.

Per the preceding description, it can be appreciated that the autonomous robotic device is capable of accumulating a great deal of data. Such data may be displayed or otherwise may be made available on the robot, or may be communicated to another location or device through a link which, consistent with the autonomous nature of the robotic device, will be wireless in nature. Within an environment in which the autonomous robotic device operates, such as a home, for example, it may be that other devices within the home may be able to use the data that the autonomous robotic device collects, to perform other functions, such as operating climate control devices (in an on/off mode, or via a thermostat), opening or closing window shades which may be remotely operated, turning lights on and off, and the like.

To this point, data collection has been described as being purely of a physical nature, where time is not a variable. The collection, then, is effectively a snapshot, in time, of conditions within a room. In one aspect, however, recording of time of data collection (time-stamping of the data) may facilitate characterization of conditions in the environment in which the autonomous robotic device is operating. The data may be displayed on the autonomous robotic device, or on another device with which the autonomous robotic device communicates. Communications may be device-to-device, device to server (cloud), and server to server (cloud to cloud).

Each signal measurement is paired with a location tag from the SLAM algorithm and a timestamp. Since the robot cannot measure different locations at different times, the measurements are affected differently, perhaps giving the impression one area has better signal quality when it usually has worse signal quality. To address this, the signal quality map is constantly updated with each pass of the robot over the same area, and an average signal quality is used. The averaging routine may throw out outlier data, such as the highest and lowest measurements. Over time, the map can determine if the pattern changes at different times of day.

Once obtained, the time-stamped data may be used for various purposes, from purely statistical analysis of some or all of the recorded conditions that the sensor data represents just for that environment, or combined (anonymously or otherwise) with data from other similar or disparate environments for various purposes.

In another aspect, the autonomous robotic device may use any or all of the sensor data, in addition to the map data. With said data associated with said map, the autonomous robot processes the data to make navigation decisions and to initiate appropriate actions.

### Home Controllers Interaction

In one embodiment, the cleaning robot can interact with other home controllers over a wireless network to optimize the operation of the cleaning robot. For example, when the robot is using a camera for object detection or other purposes, the amount of light can be detected to determine if there is sufficient light for capturing good images. If there is insufficient light, the robot can communicate through a wireless network to a light controller to have particular lights turned on.

In another example, the cleaning robot can includes a humidity sensor for detecting potential mold areas, and can treat them with a UV lamp on the robot. The robot can also have a fan turned on, since air flow can help eliminate the moisture. Alternately, a room de-humidifier may be available to be turned on. The user may input the location of the room de-humidifier, fans, or other appliances. Alternately, the cleaning robot can use a camera and other sensors to determine the location of such appliances and note them on a map. The camera could capture images, with a tagged location, and object recognition software can be used to determine which objects are appliances. A microphone can pick up sounds which can be compared to a sound signature or characteristic of an appliance. For example, a fan may have one sound while a humidifier, refrigerator or heating system air duct would have their own unique sounds.

In one embodiment, the correct identification of an appliance from object recognition is verified by the cleaning robot communicating with the appliance controller to have it turned on so that its sound can be detected, or alternately lights or a lighting pattern can be detected.

In one embodiment, the robot communications with other home controlled devices coordinates the use of the WiFi network to minimize interference. Common sources of interference include microwave transmitters, wireless cameras, baby monitors, or a neighbor's Wi-Fi device. For devices controlled in the same network, the WiFi network can be time-shared to prevent interference. Alternately, rather than coordination, the robot can simply schedule updates for when minimal interference is detected. An overall pattern of interference at different times may be learned with machine learning to estimate the best times. For example, a security camera may periodically upload a picture every minute. Where a dual band router is used, the band used by a neighbor can be determined, and a different band can be selected.

In one embodiment, the robot determines whether the environment is within its operation parameters, either directly using sensors on the robot, or through communication with other systems or devices that have the relevant sensors and data. For example, the robot may not operate if the temperature is too cold or too hot (e.g., less than 5° C., or more than 32° C.). If there is too much humidity, that may damage the electronics, and thus robot operation may be inhibited.

### Communication Hub

In one embodiment, the cleaning robot can act as a hub for communicating with other home controllers and coordinating actions. A user interface for controlling the cleaning robot also provides interfaces for operating other home controllers, such as a thermostat, lighting system, automatic door and/or window locking system, etc.

### Machine Learning

In one embodiment, machine learning is used to determine an owner's habits, and adopt accordingly. Cleanings can be done automatically at times the owner is not at home, or is in another room and typically not receiving phone calls. Lights can be turned out in other rooms when an owner's patterns indicate that room will not be used anymore that evening.

In one embodiment, temperature data can be collected over time or provided through a home network to a smart thermostat. The range of temperatures mapped can be used to provide options to the user, such as accepting a 74 degree temperature at the thermostat in the hallway near the furnace to achieve a 68 degree temperature in the bedroom far from the furnace. Based on the owner's observed room occupancy patterns, and using machine learning, a schedule can be proposed to provide a desired temperature (e.g., 72 degrees) in rooms where the owner typically is at those times.

### Noxious Element Detection and Treatment

In one embodiment, the presence of dust mites is assumed in areas of high dirt concentration on a carpet or other fabric flooring material. Dust mites feed on organic detritus, such as flakes of shed human skin. Dust mites typically inhabit the lower part of a carpet, under the carpet pile, and are difficult to detect. They typically arise where there is a high concentration of dust. On tile, hardwood, or other hard flooring surfaces, the dust and the mites are typically vacuumed up.

In one embodiment, a UV (Ultra Violet) lamp is included on the robot cleaner. The lamp is mounted on the underside of the robot, directed downward. It may also be recessed, to further decrease the likelihood of contact with human eyes. In addition, or alternately, the UV lamp may be operated under a program that suspends operation when a human is detected nearby. Such detection can be by motion detection, IR detection, monitoring of user operation of devices on the wireless network, or a combination. The UV lamp may be operated when a particulate sensor detects a greater than normal amount of dust or dirt, such as an absolute number or an amount above an average in the area by a certain amount, such as 75% above average. The UV lamp is prevented from operating when the robot cleaner is not moving to prevent damage to the carpet. A floor type sensor can be provided on the robot cleaner to determine the floor type, and inhibit the operation of the UV lamp when over a hard surface unlikely to produce dust mites. In addition, this reduces the likelihood of UV reflections into the eyes of humans, since carpet typically will not reflect or will reflect only diffusely.

In one embodiment, a dehumidifier is included on the robot, to remove moisture from areas that may develop mold. A UV lamp can also be used to kill mold. UV light works best if the light is held 1-2 inches from the effected surface and if the UV light is applied anywhere from 2-10 seconds in that area to effectively kill the mold. Repeated treatments may be required since 100% of the mold is not typically killed. Thus, the UV light in one embodiment is mounted so that it is less than 2 inches above the floor surface, or less than one inch. A humidity or moisture detector is mounted on the robot cleaner and used to identify areas that may have mold. Extensive exposure to UV light can fade a carpet or wood flooring. Thus, in one embodiment, after a predetermined number of treatments, the user is prompted to inspect and otherwise treat the area. A camera mounted on the cleaning robot make take pictures of the treated and surrounding areas to use image analysis to determine if fading has started, and inhibit further treatments and/or provide the pictures to the user.

In one embodiment, the cleaning robot includes a Volatile Organic Compound (VOC) sensor. Typical indoor VOC sources include paint, cleaning supplies, furnishings, glues, permanent markers and printing equipment. Levels can be particularly high when there is limited ventilation. In one embodiment, the cleaning robot includes an air purifier that is activated when VOCs are detected by the VOC sensor. Alternately, the user can be alerted to manually activate a separate air purifier. The cleaning robot can map where the highest concentrations of VOCs were detected, and recommend an optimum placement of a portable air purifier. Alternately, if an air purifier is connected to a network, the cleaning robot can send instructions to turn on the air purifier. Alternately, or in addition, recommendations for opening certain doors or windows can be provided, or, where automated doors and/or windows are provided, those can be instructed to be opened.

In one embodiment, the cleaning robot can map the air quality for different combinations of open doors and windows. Using machine learning over time, the optimum combination, or the one with the minimum number of open windows (or doors) can be provided for maintaining good air quality. Additionally, household fans can be factored in, with different activations and speeds being tried for different open window and door combinations to determine the optimum air flow for the best air quality. As described above, the air quality and open window, door and fan activation data can be feed over the wireless network to a machine learning application in the Cloud (over the Internet).

### Mapped Layers

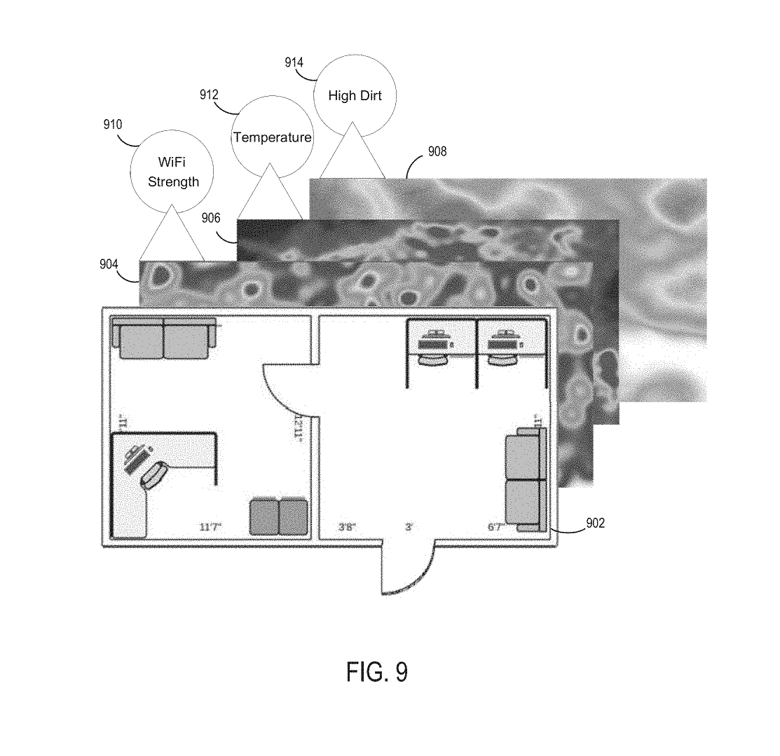

FIG. 9 is a diagram of an embodiment of a display with different map layers for different measured conditions. A layer 902 shows the floor plan as mapped by the cleaning robot. A layer 904 is a heat map using different colors to indicate the relative strength of a WiFi or other wireless signal as mapped throughout the floor plan. A layer 906 is a map of the measured temperatures. A layer 908 is a map of the high dirt concentration areas, which could be used to dictate more intensive cleaning, UV treatment for possible dust mites or mold, or other action. The display shows a tab 910 for WiFi strength, a tab 912 for Temperature and a tab 914 for high dirt areas. The user can select a tab to have the layer superimposed over the floor plan to display the relevant data. Any number of other mapping layers could be providing, including, but not limited to, the following:

### Air Quality Layer

### Moisture/Humidity Layer

### Sound map Layer

### Object Layer

### VOC (Volatile Organic Compound) Layer

In one embodiment, sensors are included on the robot cleaner to detect one or more of the following:

Acoustic noise—sound power, sound pressure and frequency,
Ambient temperature,
Localized heat and cooling sources (hot and cold spots),

### Humidity,

Air pressure (barometric and altitude),
Airflow direction and magnitude,
Ambient light,
Artificial light,
Electromagnetic frequency of illumination,
Particle radiation including alpha, beta and gamma,
Surface dirt concentration,
Airborne particulate concentrations,
Surface moisture,
Surface (floor, wall, ceiling) material and finish,
Surface coefficient of friction (slipperiness),
Surface compliance (durometer),
Surface contours (including levelness),
Surface contaminates (stains) and analysis of the type of contaminate,
Sub-surface contaminates,
Sub-surface construction and objects (pipes, studs, ducts, etc. using x-rays, ultrasonics, terahertz, etc.),
Metallic objects in floors and walls,
Magnetic signal strength and direction,
gas concentrations including CO, CO2, O2, CH4, C2H6, Radon,
Odors (sensing specific airborne molecules),
Taste (sensing specific surface molecules),
Mold spores, dust mites, other allergens,
Other airborne and surface pathogens including asbestos and lead,

### Cobwebs,

Insect and rodent or other animal scat or detritus.

### CONCLUSION

While the invention has been described with respect to specific embodiments, one skilled in the art will recognize that numerous modifications are possible. Embodiments of the invention may be realized using a variety of computer systems and communication technologies including but not limited to specific examples described herein.

Embodiments of the present invention may be realized using any combination of dedicated components and/or programmable processors and/or other programmable devices. The various processes described herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A mobile robotic system comprising:
a robotic apparatus with a housing;
a drive motor mounted in the housing;
a drive system, coupled to the drive motor, for moving the robotic apparatus;
a processor;
a distance and object detection sensor;
a wireless transceiver;
a non-transitory computer readable media, coupled to the processor, containing instructions for:
measuring a signal quality attribute of a wireless communications signal using the wireless transceiver;
generating a signal quality map of the signal quality of the wireless communications signal; and
optimizing an operation of the mobile robotic system based on the signal quality map.

2. The mobile robotic system of claim 1 wherein the instruction for optimizing an operation comprises providing an optimal location for a recharging station for the mobile cleaning robot.

3. The mobile robotic system of claim 2 wherein the instruction for optimizing an operation further comprises at least one of determining a location with an electrical outlet and determining an optimum location for a most efficient starting point for cleaning an area.

4. The mobile robotic system of claim 1 wherein the instruction for optimizing an operation comprises determining areas where the wireless communications signal may be lost, and performing one of:
avoiding areas where the wireless communications signal may be lost;
switching to another wireless communication channel;
switching to another wireless communication channel; and
switching to a local control mode not requiring wireless communications over the wireless transceiver in areas where the wireless communications signal may be lost.

5. The mobile robotic system of claim 1 wherein the instruction for measuring signal quality of a wireless communications signal using the wireless transceiver further comprises measuring the signal quality of both bands of a dual band router network.

6. The mobile robotic system of claim 1 further comprising a non-transitory computer readable media containing instructions for:
generating a plurality of map layers for display on a user electronic device, one of the layers being a map of signal quality; and
enabling a user to select a desired map layer.

7. The mobile robotic system of claim 1 further comprising a non-transitory computer readable media containing instructions for:
communicating with at least one device controller over a wireless network using the wireless transceiver;
optimizing an operation of the robotic system by instructing the at least one device controller to take an action that will affect the robotic system performance.

8. The mobile robotic system of claim 1, further comprising,
an application, downloaded to a user device, including non-transitory computer readable media with instructions for
prompting and responding to a first input command from a user;
transmitting the first input command over the wireless network to the device controller; and
prompting and responding to a second input command from a user;
transmitting the second input command over the wireless network to the processor.

9. The mobile robotic system of claim 1 further comprising a Volatile Organic Compound (VOC) sensor mounted in the housing.

10. A mobile robotic system comprising:
a housing;
a drive motor mounted in the housing;
a drive system, coupled to the drive motor, for moving the robotic apparatus;
a cleaning element, mounted in the housing;
a processor;
a distance and object detection sensor comprising a source providing collimated light output in an emitted light beam and a detector sensor operative to detect a reflected light beam from the emitted light beam incident on an object, and further comprising:
a rotating mount to which said source and said detector sensor are attached;
an angular orientation sensor operative to detect an angular orientation of the rotating mount;
a first non-transitory, computer readable media including instructions for
computing distance between the rotating mount and the object,
determining a direction of the stationary object relative to the robotic device using the angular orientation of the rotating mount, and applying a simultaneous localization and mapping (SLAM) algorithm to the distance and the direction to determine a location of the robotic device and to map an operating environment;
a second non-transitory computer readable media, coupled to the processor, containing instructions for:
measuring a signal quality attribute of a wireless communications signal using the wireless transceiver;
generating a signal quality map of the signal quality of the wireless communications signal; and
optimizing an operation of the mobile robotic system based on the signal quality map;
an application, downloaded to a user device, including non-transitory computer readable media with instructions for prompting and responding to the input command from a user and for transmitting the input command to the processor; and
a wireless receiver, mounted in the housing and coupled to the processor, for receiving the transmitted input command.

11. The mobile robotic system of claim 10 wherein the first and second non-transitory computer readable media comprise parts of a single physical media.

12. A method for controlling a mobile cleaning robot comprising:
providing a robotic apparatus with a housing, a drive motor mounted in the housing, a drive system, coupled to the drive motor, for moving the robotic apparatus, a processor, a distance and object detection sensor, and a wireless transceiver;
measuring a signal quality attribute of a wireless communications signal using the wireless transceiver;
generating a signal quality map of the signal quality of the wireless communications signal; and
optimizing an operation of the mobile robotic system based on the signal quality map.

13. The method of claim 12 wherein optimizing an operation comprises providing an optimal location for a recharging station for the mobile cleaning robot.

14. The method of claim 12 wherein the optimizing an operation further comprises at least one of determining a location with an electrical outlet and determining an optimum location for a most efficient starting point for cleaning an area.

15. The method of claim 12 wherein optimizing an operation comprises determining areas where the wireless communications signal may be lost, and performing one of:
avoiding areas where the wireless communications signal may be lost;
switching to another wireless communication channel;
switching to another wireless communication channel; and
switching to a local control mode not requiring wireless communications over the wireless transceiver in areas where the wireless communications signal may be lost.

16. The method of claim 12 wherein measuring signal quality of a wireless communications signal using the wireless transceiver further comprises measuring the signal quality of both bands of a dual band router network.

17. A non-transitory computer readable media, coupled to a processor for controlling a robot, containing instructions for:
measuring a signal quality attribute of a wireless communications signal using the wireless transceiver;
generating a signal quality map of the signal quality of the wireless communications signal; and
optimizing an operation of the mobile robotic system based on the signal quality map.

18. The non-transitory computer readable media of claim 17 wherein:
optimizing an operation comprises providing an optimal location for a recharging station for the mobile cleaning robot.

19. The non-transitory computer readable media of claim 18 wherein the optimizing an operation further comprises at least one of determining a location with an electrical outlet and determining an optimum location for a most efficient starting point for cleaning an area.

20. The non-transitory computer readable media of claim 18 wherein optimizing an operation comprises determining areas where the wireless communications signal may be lost, and performing one of:
avoiding areas where the wireless communications signal may be lost;
switching to another wireless communication channel;
switching to another wireless communication channel; and
switching to a local control mode not requiring wireless communications over the wireless transceiver in areas where the wireless communications signal may be lost.
